(19) United States
(12) Patent Application Publication
(10) Pub. No.: US 2023/0074700 A1
(43) Pub. Date: Mar. 9, 2023

(54) PREDICTION METHOD FOR CHARGING LOADS OF ELECTRIC VEHICLES WITH CONSIDERATION OF DATA CORRELATION

(71) Applicants: State Grid Shanghai Electric Power Company, Shanghai (CN); Shanghai Electric Power Trading Center Co.,Ltd., Shanghai (CN); North China Electric Power University, Beijing (CN); State Grid Electric Power Research Institute Co.,Ltd., Nanjing (CN); Beijing KeDong Electric Power Control System Co.,Ltd., Beijing (CN); State Grid Electric Vehicle Service Company, Beijing (CN)

(72) Inventors: Dunnan LIU, Beijing (CN); Mingguang LIU, Beijing (CN); Jing YANG, Shanghai (CN); Yue SHEN, Shanghai (CN); Li TAO, Nanjing (CN); Jian LIU, Nanjing (CN); Hua ZHONG, Shanghai (CN); Wen WANG, Beijing (CN); Qiqi ZHANG, Shanghai (CN); Weihua WENG, Shanghai (CN); Lingxiang WANG, Beijing (CN); Yingzhu HAN, Beijing (CN); Jianye ZOU, Beijing (CN); Xin DU, Beijing (CN); Lin ZHANG, Beijing (CN); Ye YANG, Beijing (CN); Shu SU, Beijing (CN)

(21) Appl. No.: 17/862,004

(22) Filed: Jul. 11, 2022

(30) Foreign Application Priority Data
Aug. 25, 2021 (CN) 202110978765.2

(51) Int. Cl. G06Q 30/02; G06N 5/02

(52) U.S. Cl. CPC G06Q 30/0202; G06N 5/022

(57) ABSTRACT

A prediction method for charging loads of electric vehicles with consideration of data correlation includes: collecting historical data of the charging loads of the electric vehicles; carrying out data correlation analysis on the historical data of the charging loads of the electric vehicles, and real-time data, and calculating correlation coefficients between the historical data of the charging loads of the electric vehicles and the real-time data; based on the correlation coefficients, selecting historical data of the charging loads of the electric vehicles, which has high correlation, as data of the charging loads of the electric vehicles, which is used for prediction; and predicting the historical data of the charging loads of the electric vehicles, serving as the data of the charging loads of the electric vehicles, which is used for prediction, by adopting an LSTM algorithm, to obtain prediction results.

### CROSS REFERENCE TO RELATED APPLICATIONS

This application claims foreign priority of Chinese Patent Application No. 202110978765.2, filed on Aug. 25, 2021 in the China National Intellectual Property Administration, the disclosures of all of which are hereby incorporated by reference.

### TECHNICAL FIELD

The present invention belongs to the technical field of data analysis of loads of electric vehicles, relates to a prediction method for charging loads of electric vehicles, and particularly relates to a prediction method for charging loads of electric vehicles with consideration of data correlation.

### BACKGROUND OF THE PRESENT INVENTION

As the energy and environment problems are increasingly prominent, in order to implement the national energy development strategy and construct a modern energy system which is clean, efficient, safe and sustainable, electric vehicles have been developed energetically. From 2018 to 2020, in public service vehicles, the newly increased number of electric vehicles each year is increased to 30%-50%. On March 20, in the Sub-Forum of ‘New Revolution of Automobile Industry’ of 2021 Annual Meeting of China Development High-Level Forum, Yongwei Zhang, who is the vice president and the secretary-general of the 100-People Meeting of Electric Vehicles of China, expressed that holdings of electric vehicles of China should be within a range of 80,000,000 before and after 2030 according to the prediction. The popularization of the electric vehicles has a great effect on the structure of a power demand side, which can cause new growth points of power demands and loads in a period of time in the future.

Charging behaviors of the electric vehicles have the characteristics of randomness and fluctuation, and the charging features are possibly constrained by multiple factors, such as habits of users, the SOC (State of Charge) of a system and the like. As the electric vehicles are gradually large-scale, the disorderly charging and randomness of the electric vehicles cause relevant problems, such as the increase of a peak load of a power grid, unbalanced operation of a power distribution network, harmonic waves in the system and the like. Meanwhile, the electric vehicles, serving as mobile energy storage equipment, can provide assistance in the aspects of peak clipping and valley filling of the power grid, collaborative consumption of new energy and the like after reasonable charging management is realized. However, the existing prediction method for charging loads of the electric vehicles has the defects that the prediction is very difficult, the reliability of the prediction is not high, etc.

### SUMMARY OF PRESENT INVENTION

In order to overcome the defects in the prior art, the present invention provides a prediction method for charging loads of electric vehicles with consideration of data correlation, which is reasonable in design, simple and convenient in use and reliable in prediction results.

The present invention adopts the following technical solutions to solve the practical problems:

the prediction method for the charging loads of the electric vehicles with consideration of the data correlation comprises the following steps:

Step 1: collecting historical data of charging loads of electric vehicles;

Step 2: carrying out data correlation analysis on the historical data of the charging loads of the electric vehicles, which is collected in Step 1, and real-time data, and calculating correlation coefficients between the historical data of the charging loads of the electric vehicles and the real-time data;

Step 3: according to correlation coefficients obtained through calculation in Step 2, selecting historical data of the charging loads of the electric vehicles, which has high correlation, as data of the charging loads of the electric vehicles, which is used for prediction;

Step 4: predicting the historical data of the charging loads of the electric vehicles, which has high correlation and is selected in Step 3, serving as the data of the charging loads of the electric vehicles, which is used for prediction, by adopting an LSTM (Long Short Term Memory) algorithm, to obtain prediction results.

Moreover, a specific method of the Step 1 comprises: collecting the historical data of the charging loads of the electric vehicles of that very day and ten typical days at a certain area.

Moreover, a specific method of the Step 2 comprises: calculating the correlation of historical data of the charging loads of the electric vehicles of each day and real data of that very day by utilizing Excel software, to obtain the correlation coefficients between the historical data of the charging loads of the electric vehicles and the real-time data, wherein the calculation formula is:

$${r}_{xy} = \frac{{S}_{xy}}{{S}_{x} {S}_{y}} \qquad ( 1 )$$

wherein r_{xy} represents a correlation coefficient of samples; S_{xy} represents the sample covariance; Sₓ represents the sample standard deviation of x; and S_{y} represents the sample standard deviation of y. In this case, x represents the data of the ten typical days, and y represents the data of that very day.

Moreover, a specific method of the Step 3 comprises:

according to a sequence of the correlation coefficients from small to big, selecting top five groups of data with the biggest correlation coefficients, i.e., five groups of data with the highest correlation, as the data of the charging loads of the electric vehicles, which is used for prediction.

Moreover, the Step 4 specifically comprises the following steps:

(1) inputting the data xₜ of the charging loads of the electric vehicles, which is used for prediction and is obtained in Step 3, and carrying out processing of a forgetting stage of a forgetting gate on load data xₜ of each time point firstly, wherein a calculation formula is shown as follows:

fₜ=σ(W_{f}·[hₜ₋₁,xₜ]+b_{f})

(2) then, carrying out processing of a cell state updating stage of an input gate on fₜ, wherein a calculation formula is shown as follows:

Cₜ=fₜ*Cₜ₋₁+iₜ*\tilde{C}t

(3) finally, carrying out processing of an output stage of an output gate on Cₜ, wherein calculation formulas are shown as follows:

0ₜ=σ(Wₒ·[hₜ₋₁,xₜ]+bₒ)

hₜ=0ₜ*tan h(Cₜ)

(4) taking load data obtained after the load data of one time point is processed by the three gate stages as legacy information hₜ₋₁ of a previous cell, and enabling the legacy information hₜ₋₁ and load data of a new time point to participate in recursive processing of the three gate stages again, to obtain load prediction values hₜ of 96 time points in one day finally.

The present invention has the advantages and beneficial effects that:

According to the prediction method for the charging loads of the electric vehicles with consideration of the data correlation, which is proposed by the present invention, the data correlation analysis is carried out on the historical data of the charging loads of the electric vehicles and the real-time data, and the data with the biggest correlation coefficients is selected as the load data used for prediction, so that the work load of data processing can be effectively reduced, the prediction method is simplified, and the predication accuracy is improved. Reasonable prediction of charging demands of the electric vehicles has important significance for the aspects of stable operation of a power grid, dispatching of the charging loads of the electric vehicles, researching of an orderly charging strategy and the like.

### DESCRIPTION OF THE DRAWINGS

FIG. 1 is a flow chart of processing of the present invention;

FIG. 2 is a diagram of prediction results of the present invention; and

FIG. 3 is a diagram of error percentage results of the present invention.

### DETAILED DESCRIPTION OF PREFERRED EMBODIMENTS

Embodiments of the present invention are further described in detail below through combination with the drawings.

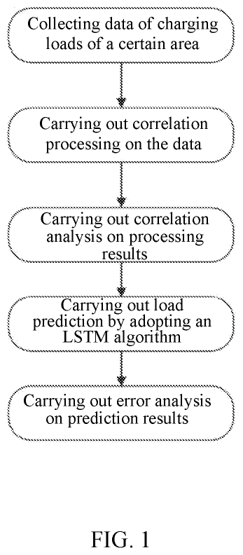

A prediction method for charging loads of electric vehicles with consideration of data correlation, as shown in FIG. 1, comprises the following steps:

Step 1: collecting historical data of the charging loads of the electric vehicles.

In the embodiment, research objects are collected, namely, historical data of charging loads of electric vehicles at a certain area is collected as basic data for correlation processing.

The research objects are collected, namely, data of charging loads at a certain area of that very day and ten typical days ((D-1)-(D-10)) is collected as basic data for correlation processing.

Step 2: carrying out data correlation analysis on the historical data of the charging loads of the electric vehicles, which is collected in the Step 1, and real-time data, and calculating correlation coefficients between the historical data of the charging loads of the electric vehicles and the real-time data.

In the embodiment, the correlation of the historical data of the charging loads of the electric vehicles of each day and real data of that very day is calculated by utilizing Excel software, to obtain the correlation coefficients between the historical data of the charging loads of the electric vehicles and the real-time data.

The data correlation analysis is carried out on the historical data (i.e., the basic data) of the charging loads of the electric vehicles and the real real-time data of that very day, and the correlation of the historical data of the charging loads of the electric vehicles of each day and the real data of that very day is calculated by utilizing the Excel software, to obtain the correlation coefficients between the historical data (i.e., the basic data) of the charging loads of the electric vehicles and the real-time data.

A correlation coefficient method is adopted in the present invention, the correlation coefficient refers to a statistical index reflecting the intimacy level of the relation between variables, and the value interval of the correlation coefficient is 1−(−1); 1 represents that the two variables are in perfect linear correlation, −1 represents that the two variables are in perfect negative correlation, and 0 represents that the two variables are uncorrelated; and the closer the data is to 0, the weaker the correlation is.

The calculation formula of the correlation coefficient in the Step 2 is shown as (1):

$${r}_{xy} = \frac{{S}_{xy}}{{S}_{x} {S}_{y}} \qquad ( 1 )$$

wherein r_{xy} represents a correlation coefficient of samples; S_{xy} represents a sample covariance; Sₓ represents a sample standard deviation of x; S_{y} represents the sample standard deviation of y; and in such the situation, x represents the data of the ten typical days, and y represents the data of that very day.

Step 3: according to the correlation coefficients obtained through calculation in the Step 2, selecting historical data of the charging loads of the electric vehicles, which has high correlation, as data of the charging loads of the electric vehicles, which is used for prediction.

The correlation of the historical data (i.e., the basic data) of the charging loads of the electric vehicles is analyzed by utilizing the correlation coefficients, and top five groups of data with the biggest correlation coefficients are selected as load data used for prediction; and according to the sequence of the correlation coefficients from small to big, the top five groups of data with the biggest correlation coefficients, i.e., the five groups of data with the highest correlation, is selected as the data of the charging loads of the electric vehicles, which is used for prediction.

Step 4: predicting the data of the charging loads of the electric vehicles, which is used for prediction and is selected in the Step 3, by adopting an LSTM algorithm, to obtain prediction results.

The Step 4 specifically comprises the following steps:

inputting the data Xₜ of the charging loads of the electric vehicles, which is used for prediction and is selected in the Step 3, and carrying out processing of a forgetting stage of a forgetting gate on load data Xₜ of each time point firstly, wherein the calculation formula is shown as follows:

fₜ=σ(W_{f}·[hₜ₋₁,xₜ]+b_{f})

then, carrying out processing of a cell state updating stage of an input gate on a result fₜ obtained by processing of the forgetting stage of the forgetting gate, wherein the calculation formula is shown as follows:

Cₜ=fₜ*Cₜ₋₁+iₜ*\tilde{C}t

finally, carrying out processing of an output stage of an output gate on Cₜ, wherein the calculation formulas are shown as follows:

0ₜ=σ(Wₒ·[hₜ₋₁,xₜ]+bₒ)

hₜ=0ₜ*tan h(Cₜ)

taking load data obtained after the load data of one time point is processed by the three gate stages as legacy information hₜ₋₁ of a previous cell, and enabling the legacy information hₜ₋₁ and load data of a new time point to participate in recursive processing of the three gate stages again, to obtain load prediction values hₜ of 96 time points in one day finally.

In the embodiment, LSTM has the structure which is generally consistent with an RNN (Recurrent Neural Network), but duplicate modules have different structures. The LSTM has four network layers which are different from a single neural network layer of the RNN, and the four network layers are interacted with one another in a very special manner. Through the manner, previous information which is distorted easily is screened and integrated into new information, and the new information is reserved; the reserved new information and new information entering at the same time are superposed at a certain proportion; and finally, the superposed information is output by a tan h function. In addition, an LSTM network can be used for capturing long time slice dependency and deciding that which information needs to be reserved, and which information needs to be forgotten.

The present invention is further described below by a specific example:

Step 1: collecting research objects, wherein in the example, data of charging loads of that very day and days (D-1)-(D-10) at a certain area is collected as basic data for correlation processing, and the details are shown in Tab. 1;

Step 2: carrying out data correlation analysis on the basic data and calculating correlation of data of each day and real data of that very day by utilizing Excel software, so as to obtain correlation coefficients between the basic data,

wherein the calculation formula of the correlation coefficient is shown as (1):

$$( 1 ) {r}_{xiy} = \frac{{S}_{xiy}}{{S}_{xi} {S}_{y}} \qquad ( 1 )$$

wherein r_{xiy} represents a correlation coefficient of an i^{th} group of samples; S_{xiy} represents the covariance of data of the day D-i and the data of that very day; Sₓᵢ represents the sample standard deviation of xi, i.e. the ten typical days (D-1)-(D-10); Sₓᵢ represents the sample standard deviation of a dependent variable y, i.e. the data of that very day; and according to the formula, the sample standard deviations of the ten days (D-1)-(D-10) and the sample standard deviation of the real data of that very day need to be calculated firstly, and then, the covariance between the data of the days (D-1)-(D-10) and the data of that very day is calculated, to obtain the correlation coefficient between predicted data according to the formula (1);

front 200 pieces of data in the collected data is calculated, to obtain the sample standard deviations of the ten days (D-1)-(D-10) and the sample standard deviation of the real data of that very day, which are respectively shown as follows:

Sₓ₁=15518.7702, Sₓ₂=15306.236, Sₓ₃=15234.1388,

Sₓ₄=15170.64539, Sₓ₅=15365.59057, Sₓ₆=15411.0932,

Sₓ₇=15365.21298, Sₓ₈=15183.83278, Sₓ₉=15254.04272,

Sₓ₁₀=15335.72268, S_{y}=15563.67394.

the covariance between the data of the days (D-1)-(D-10) and the data of that very day, which is shown as follows:

S_{x1y}=230556230.1, S_{x2y}=226709123.7, Sₓ₃₇=224826730.8,

S_{x4y}=225406997.5, S_{x5y}=230894694.9, Sₓ₆₇=234740896.6,

S_{x7y}=234712143.6, S_{x8y}=229462672.7, S_{x9y}=231249625.3,

S_{x10y}=233008103.1.

the correlation coefficients between the data of the days (D-1)-(D-10) and the data of that very day can be obtained through calculation according to the calculation formula of the correlation coefficients, which are respectively shown as follows:

r_{x1y}=0.9546, r_{x2y}=0.9517, r_{x3y}=0.9482, r_{x4y}=0.9547, r_{x5y}=0.9655,

r_{x6y}=0.9787, r_{x7y}=0.9815, r_{x8y}=0.9715, r_{x8y}=0.9741, r_{x10y}=0.9762

(Four decimals are reserved through rounding.);

The standard deviation refers to respective standard deviation of the data of the selected ten typical days, and the covariance is obtained by calculating the data of each of the ten typical days and the data of that very day; and the verified content is the correlation degree of the selected ten typical days and that very day.

Step 3: analyzing the correlation of the basic data by utilizing the correlation coefficients and selecting load data used for prediction.

The sequence of the correlation of the data of the days (D-1)-(D-10) and the data of that very day can be obtained according to the data in the Step 2, which is shown as follows: S_{x7y}>S_{x6y}>S_{x10y}>S_{x9y}>S_{x8y}>S_{x5y}>S_{x4y}>S_{x1y}>S_{x2y}>S_{x3y}.

Five days with the highest correlation with the data of that very day are a day D-7, a day D-6, a day D-10, a day D-9 and a day D-8, and therefore, the data of the five days are selected as the load data used for prediction;

Step 4: predicting the selected load data by adopting an LSTM algorithm, to obtain prediction results.

LSTM is a long short term memory network, which is a time RNN and is suitable for processing and predicting an important event with a relatively longer interval and a relatively longer delay in a time sequence.

LSTM and the RNN have the main difference that a ‘processor’ for judging that whether information is useful or not is added into the algorithm in the LSTM, and a functional structure of the processor is called a cell.

Three gates are placed in one cell, which are an input gate, a forgetting gate and an output gate; one piece of information enters the LSTM network and can be judged to be useful or not according to a rule; and only information in conformity with the algorithm is reserved, and information which is not in conformity with the algorithm is forgotten by the forgetting gate.

A process of processing the information in the cell is shown as follows:

A first stage: a forgetting stage of the forgetting gate, wherein the stage is mainly used for selectively forgetting input transmitted by a last node; simply, the stage is used for ‘forgetting unimportant information and remembering important information’; specifically, the decision is made by an S-shaped network layer of a so-called ‘forgetting gate layer’; the cell is used for receiving legacy information hₜ₋₁ of a last cell and external information xₜ, and for each number in a cell state Cₜ₋₁, the output value is between 0 and 1; 1 represents ‘completely accepting the information’, and 0 represents ‘completely neglecting the information’; and a forgetting formula is shown as (2):

fₜ=σ(W_{f}·[hₜ₋₁,xₜ]+b_{f}) (2)

wherein fₜ represents data information after being processed by the forgetting gate; W_{f} represents a weight matrix; b_{f} represents an offset vector corresponding to the forgetting gate; hₜ₋₁ represents the legacy information of the last cell; xₜ represents input external data information; and σ represents carrying out forgetting processing of the forgetting gate on the data.

A second stage: a cell state updating stage of the input gate, wherein the stage is used for selectively ‘remembering’ input in the stage, comprising two parts: a first part is that an S-shaped network layer of a so-called ‘input gate layer’ is used for determining that which information needs to be updated, and a second part is that a tan h-shaped network layer is used for establishing a new alternative value vector \tilde{C}t, which can be added into the cell state; the above two parts are combined in the next step, so as to update the state;

Results obtained in the above two steps are added, so as to obtain Cₜ after state updating, and a cell state updating formula is shown as (3):

Cₜ=fₜ*Cₜ₋₁+iₜ*\tilde{C}t (3)

wherein Cₜ represents a cell state after being updated; fₜ represents data information after being processed by the forgetting gate; Cₜ₋₁ represents a state before the cell is updated; \tilde{C}t represents the new alternative value vector established by the tan h-shaped network layer; and iₜ represents an established parameter calculated by the input gate.

A third stage: an output stage of the output gate, wherein the stage is used for deciding that which information is regarded as output of a current state; firstly, the S-shaped network layer is operated, which is used for determining that which parts in the cell state can be output: then, the cell state is input into tan h (the numerical value is adjusted between −1 and 1.) and then is multiplied by the output value of the S-shaped network layer, so that the parts which a user wants to output can be output; and output formulas are shown as (4) and (5):

0ₜ=σ(Wₒ·[hₜ₋₁,xₜ]+bₒ) (4)

hₜ=0ₜ*tan h(Cₜ) (5)

The meanings of symbols are the same as the meanings of the above symbols.

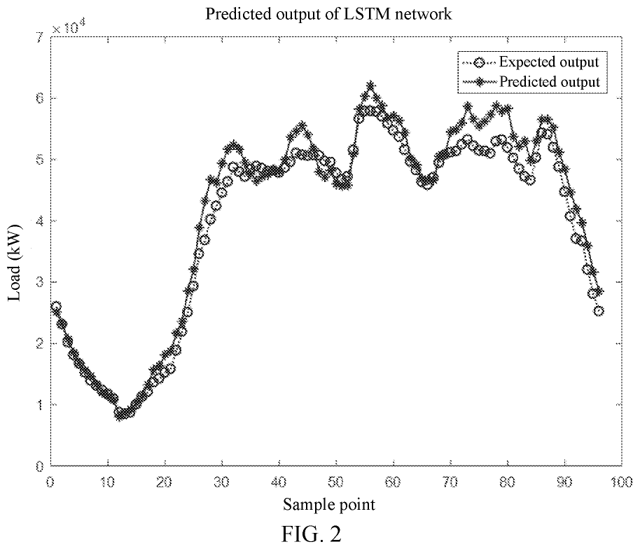

LSTM prediction is carried out on the data by adopting MATLAB (Matrix Laboratory) software, and prediction results are shown in Tab. 2; a diagram of the prediction results is shown in FIG. 2, wherein predicted output refers to prediction results obtained according to five groups of load data which has the highest correlation coefficients and is used for prediction, and expected output refers to the real data of that very day; and it can be seen from the prediction results in FIG. 2 that the fitting degree of the predicted output and the expected output is good; and

Step 5: analyzing the prediction results by adopting an error analysis method and evaluating the accuracy of the prediction method.

The results are explained by adopting the error analysis method based on the prediction results; and an error calculation formula is shown as (6):

Cₜ=(Q_{ct}−Q_{yt})/Q_{ct} (6)

wherein Cₜ represents the error percentage at a moment t; Q_{ct} represents the actual value at the moment t; Q_{yt} represents the prediction value at the moment t; and the error analysis method can be used for effectively evaluating the prediction accuracy and proving the prediction accuracy.

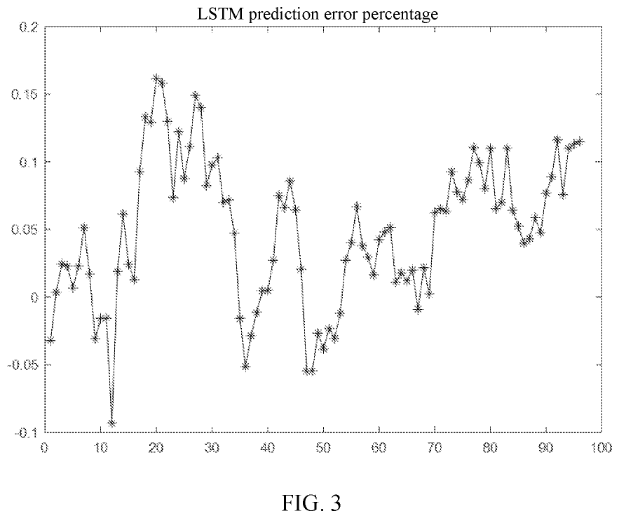

A diagram of error prediction percentage results is shown in FIG. 3, the error range of the prediction results at the time is: (−0.1, 0.16], and the maximum prediction error is 16%, which proves that the prediction method is good, and the credibility is higher. Moreover, the overall prediction method is small in calculated amount, relatively easy in calculation difficulty and higher in operability.

TABLE 1

| Time | D-1 load | D-2 load | D-3 load | D-4 load | D-5 load | D-6 load |
|---|---|---|---|---|---|---|
| point | data | data | data | data | data | data |
| 1 | 44543 | 40134.48 | 48603.71 | 49001.1233 | 47747.6533 | 51246.99 |
| 2 | 39089.2467 | 35961.72 | 44701.79 | 45634.93 | 43371.9633 | 51246.99 |
| 3 | 35626.2233 | 32606.2133 | 41699.0967 | 41656.3933 | 40661.7767 | 51246.99 |
| 4 | 32862.2233 | 28800.4033 | 39009.6567 | 38487.1633 | 38484.5667 | 51246.99 |
| 5 | 31366.73 | 28786.2033 | 37829.33 | 38109.43 | 36966.96 | 51246.99 |
| 6 | 27394.7733 | 26815.5167 | 33262.0667 | 34165.8767 | 32620.0233 | 34068.3633 |
| 7 | 24655.7333 | 23999.3567 | 29858.6267 | 30571.0867 | 28691.35 | 30119.31 |
| 8 | 22012.09 | 22247.5567 | 26473.8433 | 28691.63 | 26258.17 | 28010.2567 |
| 9 | 21940.68 | 23287.56 | 26147.07 | 29873.34 | 26047.7667 | 27503.9333 |
| 10 | 20108.4133 | 20482.9167 | 23603.8633 | 28651.1433 | 23390.4233 | 24875.2833 |
| 11 | 18457.0333 | 18114.8333 | 21278.9267 | 22119.2667 | 21084.2133 | 22254.46 |
| 12 | 16584.4633 | 16704.19 | 19614.17 | 20150.0667 | 18504.42 | 20036.8867 |
| 13 | 16095.4 | 15633.3167 | 17841.6867 | 18442.02 | 17468.69 | 18314.2967 |
| 14 | 15477.37 | 14372.28 | 16482.02 | 17288.8933 | 15913.2433 | 16326.7267 |
| 15 | 14437.92 | 13477.43 | 14926.0633 | 15497.21 | 14331.9133 | 14879.1 |
| 16 | 13492.7533 | 12130.7967 | 14419.9667 | 14275.6233 | 13283.03 | 13792.3433 |
| 17 | 12589.4633 | 11167.0933 | 13541.2833 | 13187.7833 | 12613.0367 | 13040.6367 |
| 18 | 11902.1667 | 10107.7867 | 12578.3633 | 12725.2833 | 11666.3967 | 12526.1767 |
| 19 | 10873 | 9413.2333 | 11422.98 | 12393.13 | 10950.25 | 11823.92 |
| 20 | 8382 | 7176.2167 | 8800.72 | 10165.3067 | 8334.1933 | 9430.4733 |
| 21 | 8445.0833 | 7455.3633 | 8226.54 | 9861.4233 | 8385.5233 | 8976.57 |
| 22 | 8971.2233 | 8004.3167 | 8674.1533 | 9845.7033 | 8749.34 | 9225.18 |
| 23 | 9967.4033 | 9657.6033 | 10545.54 | 10606.4 | 10149.02 | 9754.01 |
| 24 | 11262.1933 | 10686.0433 | 12038.9767 | 11082.4 | 11968.54 | 11538.7367 |
| 25 | 11813.5667 | 11720.64 | 13079.9367 | 12176.0167 | 13019.45 | 13065.7967 |
| 26 | 12806.1733 | 13568.0367 | 14252.7867 | 14144.54 | 14707.5833 | 15128.4833 |
| 27 | 13076.99 | 14301.2867 | 14843.2667 | 14992.01 | 15322.9467 | 16085.76 |
| 28 | 15268.38 | 14292.4467 | 15360.96 | 16223.3833 | 16411.28 | 16619.08 |
| 29 | 16465.36 | 14161.6533 | 16259.13 | 17423.4 | 16761.74 | 18170.1767 |
| 30 | 18676.53 | 16257.8233 | 18990.0733 | 20323.88 | 19672.31 | 22234.8 |
| 31 | 21554.7533 | 17869.9867 | 22306.21 | 22762.9133 | 21976.79 | 25177.9633 |
| 32 | 26224.95 | 20692.25 | 22770.4933 | 27301.42 | 27079.4333 | 28196.04 |
| 33 | 31022.74 | 23004.7733 | 24221.1867 | 32792.3367 | 32041.9767 | 33505.5633 |
| 34 | 37988.57 | 27885.7733 | 27912.8733 | 39025.7633 | 35271.26 | 37256.65 |
| 35 | 42202.2767 | 29597.75 | 29533.7367 | 41694.8967 | 37362.1867 | 42488.9533 |
| 36 | 46249.02 | 31962.49 | 31078.5933 | 43793.7833 | 41883.3133 | 44753.57 |
| 37 | 48737.2533 | 33604.0467 | 31430.5967 | 45638.5233 | 43485.66 | 46475.4833 |
| 38 | 50681.75 | 34790.8433 | 35408.08 | 47471.9733 | 43754.3167 | 46632.7267 |
| 39 | 54448.7433 | 37309.83 | 38711.2033 | 47370.8767 | 46405.19 | 49172.7967 |
| 40 | 55775.89 | 39461.5367 | 39852.01 | 49895.6033 | 48717.3767 | 47910.31 |
| 41 | 52615.02 | 39521.91 | 40231.3533 | 48539.29 | 47019.4233 | 45729.9833 |
| 42 | 50186.37 | 39651.37 | 40398.63 | 46393.5067 | 45788.2633 | 47903.9567 |
| 43 | 49244.7967 | 41845.0933 | 42576.0267 | 45725.4533 | 47120.6167 | 49347.7633 |
| 44 | 50204.72 | 40994.17 | 43307.2 | 46529.1333 | 47389.4567 | 47477.7567 |
| 45 | 51037.1333 | 42460.3 | 43889.2833 | 46026.6 | 45056.3767 | 47338.4767 |
| 46 | 52942.5567 | 40702.2833 | 44396.5267 | 46265.91 | 45616.05 | 48584.5933 |
| 47 | 52226.2267 | 41461.43 | 42915.49 | 46447.5233 | 45756.78 | 48418.4667 |
| 48 | 50617.04 | 40256.9467 | 41084.1833 | 47520.88 | 46672.39 | 49063.34 |
| 49 | 53435.7067 | 40871.0667 | 41350.2267 | 47728.7467 | 47373.0667 | 49551.17 |
| 50 | 55894.4333 | 39772.3 | 42932.19 | 50100.4267 | 47448.1333 | 50673.1333 |
| 51 | 58671.6067 | 42605.7233 | 44201.41 | 52429.6833 | 49707.11 | 53960.73 |
| 52 | 60282.91 | 42414.6067 | 44148.11 | 52389.9533 | 49064.43 | 54009.3233 |
| 53 | 59746.5833 | 44637.2467 | 43135.7533 | 52481.25 | 49023.9667 | 52536.8467 |
| 54 | 56654.12 | 44385.2567 | 43101.1933 | 49922.79 | 48106.0833 | 49979.8633 |
| 55 | 54530.6167 | 44637.6967 | 44414.6267 | 49093.2433 | 48177.6 | 48933.4733 |
| 56 | 52865.4867 | 45858.38 | 42641.07 | 47319.8267 | 48231.1 | 47237.1533 |
| 57 | 52192.58 | 47123.6033 | 42778.66 | 46101.2567 | 48681.5567 | 45931.6 |
| 58 | 49023.85 | 46340.2 | 41152.5833 | 45533.9567 | 46606.7767 | 43213.0367 |
| 59 | 48683.2567 | 45649.5533 | 41183.27 | 44442.39 | 45831.9033 | 43408.4633 |
| 60 | 47738.2967 | 46941.6933 | 41689.7867 | 43729.38 | 44593.28 | 43017.0267 |
| 61 | 52712.0767 | 50945.49 | 45864.1067 | 47405.6167 | 49167.5067 | 46765.14 |
| 62 | 56547.1167 | 56476.6533 | 52494.2633 | 52955.1967 | 54684.6767 | 54831.5933 |
| 63 | 59380.1967 | 59398.7533 | 54003.4233 | 55442.1133 | 56157.1333 | 57270.7533 |
| 64 | 59350.6233 | 60313.4567 | 52646.87 | 54950.17 | 57127.8567 | 58745.0633 |
| 65 | 59974.49 | 59394.8 | 51736.7533 | 55123.1433 | 56878.7633 | 56967.0633 |
| 66 | 60713.5967 | 60112.7367 | 51456.4967 | 53665.73 | 54528.49 | 56342.3433 |
| 67 | 59790.3833 | 58770.6033 | 50036.0133 | 55139.1067 | 53294.7033 | 55131.6967 |
| 68 | 59760.4367 | 58533.4367 | 48552.17 | 52108.1033 | 52284.8267 | 54595.4533 |
| 69 | 56626.7333 | 56089.1133 | 47884.3133 | 50689.4867 | 51628.91 | 52334.96 |
| 70 | 53322.95 | 54302.9467 | 44517.3967 | 48640.32 | 48951.4267 | 48586.3933 |
| 71 | 53155.9567 | 52608.1233 | 43378.03 | 46153.3633 | 47069.0833 | 48018.9467 |
| 72 | 49368.0033 | 51122.3067 | 42547.9867 | 43479.1767 | 45558.54 | 48446.5467 |
| 73 | 49793.5333 | 48580.0933 | 40915.5367 | 41253.61 | 43462.2 | 44757.9633 |
| 74 | 48909.6933 | 46737.8067 | 40032.8633 | 39900.18 | 44551.4767 | 45613.2733 |
| 75 | 50498.4667 | 47719.3933 | 41659.22 | 37788.2733 | 46349.0233 | 47302.55 |
| 76 | 51850.3567 | 50342.7033 | 43962.4333 | 41673.8867 | 48063.2433 | 52229.6467 |
| 77 | 55452.65 | 50405.1333 | 44582.15 | 44960.2267 | 51478.1867 | 51844.8567 |
| 78 | 55863.7033 | 49052.5867 | 45149.2567 | 48339.7133 | 50726.8133 | 51533.5667 |
| 79 | 56279.0767 | 50075.8433 | 43455.6633 | 47375.9667 | 51944.8767 | 52569.43 |
| 80 | 55541.66 | 49666.2633 | 45089.8633 | 50385.0667 | 52830.1833 | 53643.0567 |
| 81 | 57303.9433 | 51725.0967 | 45573.94 | 51045.1467 | 53395.1233 | 53608.3167 |
| 82 | 57050.64 | 48654.84 | 44095.4033 | 52383.97 | 50640.6367 | 52739.0067 |
| 83 | 56332.5333 | 48331.9633 | 41454.7833 | 50791.5833 | 52316.23 | 51928.0967 |
| 84 | 57601.11 | 48404.2533 | 42103.58 | 50524.2167 | 51505.9267 | 51156.2467 |
| 85 | 54551.95 | 48378.45 | 40909.2833 | 51434.3367 | 49792.8167 | 50937.19 |
| 86 | 55304.1733 | 49683.0667 | 44489.7733 | 50571.18 | 51490.3933 | 51008.0133 |
| 87 | 55673.3 | 52039.1333 | 45351.75 | 49991.08 | 51839.78 | 53734.8133 |
| 88 | 55440.21 | 51834.24 | 44707.5067 | 50331.95 | 50225.4933 | 53948.3233 |
| 89 | 51926.9867 | 48290.6133 | 43343.5267 | 47240.6367 | 49137.0433 | 50046.0567 |
| 90 | 50043.9267 | 47337.1833 | 41701.55 | 47059.7267 | 48025.8233 | 49933.0733 |
| 91 | 50223.3 | 46257.4667 | 40287.2367 | 45062.18 | 47280.05 | 48277.12 |
| 92 | 50213.5033 | 46953.9633 | 39426.7073 | 43955.7167 | 43937.89 | 45897.29 |
| 93 | 52865.4533 | 48987.6933 | 43724.9833 | 47043.61 | 48125.54 | 48271.2967 |
| 94 | 54484.6167 | 51017.11 | 50202.0233 | 51301.8533 | 52009.7833 | 53016.4133 |
| 95 | 55352.1367 | 51733.95 | 48751.6333 | 50829.8133 | 53375.97 | 54919.5433 |
| 96 | 54269.61 | 48989.3 | 44903 | 52004.9033 | 52088.4833 | 53647.9467 |
| 1 | 50311.55 | 44543 | 40134.48 | 48603.71 | 49001.1233 | 47747.6533 |
| 2 | 46806.4633 | 39089.2467 | 35961.72 | 44701.79 | 45634.93 | 43371.9633 |
| 3 | 44241.7267 | 35626.2233 | 32606.2133 | 41699.0967 | 41656.3933 | 40661.7767 |
| 4 | 40767.79 | 32862.2233 | 28800.4033 | 39009.6567 | 38487.1633 | 38484.5667 |
| 5 | 40518.69 | 31366.73 | 28786.2033 | 37829.33 | 38109.43 | 36966.96 |
| 6 | 35955.8167 | 27394.7733 | 26815.5167 | 33262.0667 | 34165.8767 | 32620.0233 |
| 7 | 31376.6067 | 24655.7333 | 23999.3567 | 29858.6267 | 30571.0867 | 28691.35 |
| 8 | 27084.19 | 22012.09 | 22247.5567 | 26473.8433 | 28691.63 | 26258.17 |
| 9 | 25995.58 | 21940.68 | 23287.56 | 26147.07 | 29873.34 | 26047.7667 |
| 10 | 23012.1067 | 20108.4133 | 20482.9167 | 23603.8633 | 28651.1433 | 23390.4233 |
| 11 | 20675.3067 | 18457.0333 | 18114.8333 | 21278.9267 | 22119.2667 | 21084.2133 |
| 12 | 18431.53 | 16584.4633 | 16764.19 | 19614.17 | 20150.0667 | 18504.42 |
| 13 | 17176.34 | 16095.4 | 15633.3167 | 17841.6867 | 18442.02 | 17468.69 |
| 14 | 15529.9 | 15477.37 | 14372.28 | 16482.02 | 17288.8933 | 15913.2433 |
| 15 | 14518.38 | 14437.92 | 13477.43 | 14926.0633 | 15497.21 | 14331.9133 |
| 16 | 13545.9167 | 13492.7533 | 12130.7967 | 14419.9667 | 14275.6233 | 13283.03 |
| 17 | 12745.38 | 12589.4633 | 11167.0933 | 13541.2833 | 13187.7833 | 12613.0367 |
| 18 | 12734.4167 | 11902.1667 | 10107.7867 | 12578.3633 | 12725.2833 | 11666.3967 |
| 19 | 12288.7633 | 10873 | 9413.2333 | 11422.98 | 12393.13 | 10950.25 |
| 20 | 9395.35 | 8382 | 7176.2167 | 8800.72 | 10165.3067 | 8334.1933 |
| 21 | 8800.89 | 8445.0833 | 7455.3633 | 8226.54 | 9861.4233 | 8385.5233 |
| 22 | 8901.1933 | 8971.2233 | 8004.3167 | 8674.1533 | 9845.7033 | 8749.34 |
| 23 | 9738.4933 | 9967.4033 | 9657.6033 | 10545.54 | 10606.4 | 10149.02 |
| 24 | 11160.9033 | 11262.1933 | 10686.0433 | 12038.9767 | 11082.4 | 11968.54 |
| 25 | 11840.8233 | 11813.5667 | 11720.64 | 13079.9367 | 12176.0167 | 13019.45 |
| 26 | 14106.7033 | 12806.1733 | 13568.0367 | 14252.7867 | 14144.54 | 14707.5833 |
| 27 | 14740.92 | 13076.99 | 14301.2867 | 14843.2667 | 14992.01 | 15322.9467 |
| 28 | 16245.94 | 15268.38 | 14292.4467 | 15360.96 | 16223.3833 | 16411.28 |
| 29 | 17407.41 | 16465.36 | 14161.6533 | 16259.13 | 17423.4 | 16761.74 |
| 30 | 20723.14 | 18676.53 | 16257.8233 | 18990.0733 | 20323.88 | 19672.31 |
| 31 | 24489.88 | 21554.7533 | 17869.9867 | 22306.21 | 22762.9133 | 21976.79 |
| 32 | 27406.2367 | 26224.95 | 20692.25 | 22770.4933 | 27301.42 | 27079.4333 |
| 33 | 33193.34 | 31022.74 | 23004.7733 | 24221.1867 | 32792.3367 | 32041.9767 |
| 34 | 38823.2967 | 37988.57 | 27885.7733 | 27912.8733 | 39025.7633 | 35271.26 |
| 35 | 42388.0767 | 42202.2767 | 29597.75 | 29533.7367 | 41694.8967 | 37362.1867 |
| 36 | 45534.87 | 46249.02 | 31962.49 | 31078.5933 | 43793.7833 | 41883.3133 |
| 37 | 50573.2167 | 48737.2533 | 33604.0467 | 31430.5967 | 45638.5233 | 43485.06 |
| 38 | 50733.81 | 50681.75 | 34790.8433 | 35408.08 | 47471.9733 | 43754.3167 |
| 39 | 50489.0933 | 54448.7433 | 37309.83 | 38711.2033 | 47370.8767 | 46405.19 |
| 40 | 52425.6467 | 55775.89 | 39461.5367 | 39852.01 | 49895.6033 | 48717.3767 |
| 41 | 50949.9233 | 52615.02 | 39521.91 | 40231.3533 | 48539.29 | 47019.4233 |
| 42 | 51110.0267 | 50186.37 | 39651.37 | 40398.63 | 46393.5067 | 45788.2633 |
| 43 | 51865.8833 | 49244.7967 | 41845.0933 | 42576.0267 | 45725.4533 | 47120.6167 |
| 44 | 51576.77 | 50204.72 | 40994.17 | 43307.2 | 46529.1333 | 47389.4567 |
| 45 | 51029.6667 | 51037.1333 | 42460.3 | 43889.2833 | 46026.6 | 45056.3767 |
| 46 | 49118.66 | 52942.5567 | 40702.2833 | 44396.5267 | 46265.91 | 45616.05 |
| 47 | 50315.23 | 52226.2267 | 41461.43 | 42915.49 | 46447.5233 | 45756.78 |
| 48 | 51728.6233 | 50617.04 | 40256.9467 | 41084.1833 | 47520.88 | 46672.39 |
| 49 | 53476.8033 | 53435.7067 | 40871.0667 | 41350.2267 | 47728.7467 | 47373.0667 |
| 50 | 54572.4567 | 55894.4333 | 39772.3 | 42932.19 | 50100.4267 | 47448.1333 |
| 51 | 55347.28 | 58671.6067 | 42605.7233 | 44201.41 | 52429.6833 | 49707.11 |
| 52 | 55559.9633 | 60282.91 | 42414.6067 | 44148.11 | 52389.9533 | 49064.43 |
| 53 | 53866.2433 | 59746.5833 | 44637.2467 | 43135.7533 | 52481.25 | 49023.9667 |
| 54 | 55622.8333 | 56654.12 | 44385.2567 | 43101.1933 | 49922.79 | 48106.0833 |
| 55 | 53672.0833 | 54530.6167 | 44637.6967 | 44414.6267 | 49093.2433 | 48177.6 |
| 56 | 51888.51 | 52865.4867 | 45858.38 | 42641.07 | 47319.8267 | 48231.1 |
| 57 | 50447.7867 | 52192.58 | 47123.6033 | 42778.66 | 46101.2567 | 48681.5567 |
| 58 | 47793.5767 | 49023.85 | 46340.2 | 41152.9113 | 45533.9567 | 46606.7767 |
| 59 | 44960.6467 | 48683.2567 | 45649.5533 | 41183.27 | 44442.39 | 45831.9033 |
| 60 | 46736.9867 | 47738.2967 | 46941.6933 | 41689.7867 | 43729.38 | 44593.28 |
| 61 | 51801.0167 | 52712.0767 | 50945.49 | 45864.1067 | 47405.6167 | 49167.5067 |
| 62 | 57223.8833 | 56547.1167 | 56476.6533 | 52494.2633 | 52955.1967 | 54684.6767 |
| 63 | 58591.3 | 59380.1967 | 59398.7533 | 54003.4233 | 55442.1133 | 56157.1333 |
| 64 | 59861.6667 | 59350.6233 | 60313.4567 | 52646.87 | 54950.17 | 57127.8567 |
| 65 | 60254.8767 | 59974.49 | 59394.8 | 51736.7533 | 55123.1433 | 56878.7633 |
| 66 | 60093.5733 | 60713.5967 | 60112.7367 | 51456.4967 | 53665.73 | 54528.49 |
| 67 | 57370.28 | 59790.3833 | 58770.6033 | 50036.0133 | 55139.1067 | 53294.7033 |
| 68 | 55943.0167 | 59760.4367 | 58533.4367 | 48552.17 | 52108.1033 | 52284.8267 |
| 69 | 53994.0667 | 56626.7333 | 56089.1133 | 47884.3133 | 50689.4867 | 51628.91 |
| 70 | 52683.1167 | 53322.95 | 54302.9467 | 44517.3967 | 48640.32 | 48951.4267 |
| 71 | 50583.7733 | 53155.9567 | 52608.1233 | 43378.03 | 46153.3633 | 47069.0833 |
| 72 | 49700.42 | 49368.0033 | 51122.3067 | 42547.9867 | 43479.1767 | 45558.54 |
| 73 | 47664.32 | 49793.5333 | 48580.0933 | 40915.5367 | 41253.61 | 43462.2 |
| 74 | 46875.32 | 48909.6933 | 46737.8067 | 40032.8633 | 39900.18 | 44551.4767 |
| 75 | 47756.39 | 50498.4667 | 47719.3933 | 41659.22 | 37788.2733 | 46349.0233 |
| 76 | 50948.63 | 51850.3567 | 50342.7033 | 41962.4333 | 41673.8867 | 48063.2433 |
| 77 | 50716.0767 | 55452.65 | 50405.1333 | 44582.15 | 44960.2267 | 51478.1867 |
| 78 | 51333.28 | 55863.7033 | 49052.5867 | 45149.2567 | 48339.7133 | 50726.8133 |
| 79 | 53208.8367 | 56279.0767 | 50075.8433 | 43455.6633 | 47375.9667 | 51944.8767 |
| 80 | 53611.2967 | 55541.66 | 49666.2633 | 45089.8633 | 50385.0667 | 52830.1833 |
| 81 | 54716.3667 | 57303.9433 | 51725.0967 | 45573.94 | 51045.1467 | 53395.1233 |
| 82 | 55056.8667 | 57050.64 | 48654.84 | 44095.4033 | 52383.97 | 50640.6367 |
| 83 | 54977.8233 | 56332.5333 | 48331.9633 | 41454.7833 | 50791.5833 | 52316.23 |
| 84 | 54358.2933 | 57601.11 | 48404.2533 | 42103.58 | 50524.2167 | 51505.9267 |
| 85 | 55952.3167 | 54551.95 | 48378.45 | 40909.2833 | 51434.3367 | 49792.8167 |
| 86 | 57297.0333 | 55304.1733 | 49683.0667 | 44489.7733 | 50571.18 | 51490.3933 |
| 87 | 57082.5333 | 55673.3 | 52039.1333 | 45351.75 | 49991.08 | 51839.78 |
| 88 | 55108.31 | 55440.21 | 51834.24 | 44707.5067 | 50331.95 | 50225.4933 |
| 89 | 51704.26 | 51926.9867 | 48290.6133 | 43343.5267 | 47240.6367 | 49137.0433 |
| 90 | 49311.3367 | 50043.9267 | 47337.1833 | 41701.55 | 47059.7267 | 48025.8233 |
| 91 | 47748.6033 | 50223.3 | 46257.4667 | 40287.2367 | 45062.18 | 47280.05 |
| 92 | 49275.4133 | 50213.5033 | 46953.9633 | 39426.7033 | 43955.7167 | 43937.89 |
| 93 | 51911.2733 | 52865.4533 | 48987.6933 | 43724.9833 | 47043.61 | 48125.54 |
| 94 | 54758.1 | 54484.6167 | 51017.11 | 50202.0233 | 51301.8533 | 52009.7833 |
| 95 | 54655.67 | 55352.1367 | 51733.95 | 48751.6333 | 50829.8133 | 53375.97 |
| 96 | 52450.2167 | 54269.61 | 48989.3 | 44903 | 52004.9033 | 52088.4833 |
| 1 | 49606.8633 | 50311.55 | 44543 | 40134.48 | 48603.71 | 49001.1233 |
| 2 | 45286.3467 | 46806.4633 | 39089.2467 | 35961.72 | 44701.79 | 45634.93 |
| 3 | 41268.47 | 44241.7267 | 35626.2233 | 32606.2133 | 41699.0967 | 41656.3933 |
| 4 | 38273.99 | 40767.79 | 32862.2233 | 28800.4033 | 39009.6567 | 38487.1633 |
| 5 | 37587.2233 | 40518.69 | 31366.73 | 28786.2033 | 37829.33 | 38109.43 |
| 6 | 33435.98 | 35955.8167 | 27394.7733 | 26815.5167 | 33262.0667 | 34165.8767 |
| 7 | 28801.48 | 31376.6067 | 24655.7333 | 23999.3567 | 29858.6267 | 30571.0867 |
| 8 | 24920.7367 | 27084.19 | 22012.09 | 22247.5567 | 26473.8433 | 28691.63 |

| Time | D-7 load | D-8 load | D-9 load | D-10 load | Real load |
|---|---|---|---|---|---|
| point | data | data | data | data | data |
| 1 | 52434.03 | 40191.5 | 41116.72 | 48506.05 | 50311.55 |
| 2 | 46582.25 | 37202.33 | 37181.31 | 45061.33 | 46806.4633 |
| 3 | 41558.41 | 35204.08 | 33767.97 | 41991.11 | 44241.7267 |
| 4 | 37464.2 | 32284.57 | 31351.88 | 37803.94 | 40767.79 |
| 5 | 33122.45 | 28433.35 | 28219.29 | 32072.35 | 40518.69 |
| 6 | 30257.78 | 24799.11 | 25796.94 | 27243.78 | 35955.8167 |
| 7 | 28003.34 | 21212.74 | 23274.91 | 24779.63 | 31376.6067 |
| 8 | 24669.44 | 18527.38 | 20564.34 | 21019.12 | 27084.19 |
| 9 | 21133.33 | 15815.77 | 18609.44 | 17756.87 | 25995.58 |
| 10 | 18786.61 | 14517.97 | 16368.28 | 15302.42 | 23012.1067 |
| 11 | 16312.75 | 13306.01 | 14193.87 | 14027.37 | 20675.3067 |
| 12 | 14835.1 | 11453.71 | 12904.31 | 12732.62 | 18431.53 |
| 13 | 13465.43 | 10055.57 | 11372.61 | 11662.92 | 17176.34 |
| 14 | 11733.24 | 9289.72 | 10969.77 | 10501.89 | 15529.9 |
| 15 | 10904.43 | 8849.7 | 10354.59 | 9416.7 | 14518.38 |
| 16 | 10461.67 | 8628.13 | 9434.78 | 8717.73 | 13545.9167 |
| 17 | 10585.54 | 8148.51 | 8264.92 | 8185.43 | 12745.38 |
| 18 | 10219.77 | 8015.61 | 8055.37 | 8186.42 | 12734.4167 |
| 19 | 9844.92 | 7400.12 | 8013.94 | 7722.24 | 12288.7633 |
| 20 | 9642.63 | 7518.16 | 8028.53 | 7776.44 | 9395.35 |
| 21 | 9275.17 | 7515 | 8215.8 | 7632.78 | 8800.89 |
| 22 | 8803.54 | 8076.19 | 8631.66 | 8071.28 | 8901.1933 |
| 23 | 9727.69 | 8981.79 | 8883.5 | 9983.56 | 9738.4933 |
| 24 | 10739.41 | 10034.21 | 9907.36 | 10782.9 | 11160.9033 |
| 25 | 11542.27 | 10739.33 | 11621.47 | 11483.68 | 11840.8233 |
| 26 | 12815.85 | 11796.06 | 12994.09 | 12166.33 | 14106.7033 |
| 27 | 13640.44 | 13970.71 | 13692.88 | 12572.59 | 14740.92 |
| 28 | 14801.97 | 15136.93 | 13863.81 | 13211.34 | 16245.94 |
| 29 | 14876.21 | 16271.65 | 14923.86 | 14212.17 | 17407.41 |
| 30 | 19992.02 | 19420.16 | 10467.38 | 16584.77 | 20723.14 |
| 31 | 21135.57 | 20276.75 | 17464.05 | 17972.71 | 24489.88 |
| 32 | 25483.38 | 23583.01 | 19996.7 | 21509.21 | 27406.2367 |
| 33 | 30167.03 | 29927.57 | 23005.37 | 24682.93 | 33193.34 |
| 34 | 35162.31 | 33794.87 | 24187.02 | 30602.26 | 38823.2967 |
| 35 | 37703.32 | 37404.38 | 27087.36 | 33974.41 | 42388.0767 |
| 36 | 41963.84 | 40941.54 | 28918.27 | 36663.53 | 45534.87 |
| 37 | 42873.6 | 43337.51 | 31322.68 | 39624.99 | 50573.2167 |
| 38 | 45703.62 | 47013.26 | 33384.46 | 40084.74 | 50733.81 |
| 39 | 45955.59 | 47693.35 | 35937.98 | 41048.01 | 50489.0933 |
| 40 | 47823.55 | 49070.66 | 35040.14 | 40517.95 | 52425.6467 |
| 41 | 44915.04 | 50504.23 | 36570.33 | 39464.05 | 50949.9233 |
| 42 | 43973.65 | 49377.28 | 37729.74 | 36884.1 | 51110.0267 |
| 43 | 43418.73 | 46848.93 | 39059.56 | 37844.24 | 51865.8833 |
| 44 | 43472.66 | 47534.91 | 38574.48 | 38166.65 | 51576.77 |
| 45 | 43615.91 | 48153.3 | 37601.82 | 39594.23 | 51029.6667 |
| 46 | 44758.36 | 48658.64 | 39290.08 | 37901.31 | 49118.66 |
| 47 | 44759.32 | 49700.28 | 35933.11 | 38547.68 | 50315.23 |
| 48 | 42631.18 | 49123.43 | 36418.67 | 39284.35 | 51728.6233 |
| 49 | 42862.19 | 52222.53 | 37091.95 | 34266.91 | 53476.8033 |
| 50 | 45073.28 | 52929.41 | 36654.57 | 49161.74 | 54572.4567 |
| 51 | 46226.34 | 53331.62 | 37432.97 | 49916.75 | 55347.28 |
| 52 | 46641.81 | 52656.41 | 38206.46 | 50687.65 | 55559.9633 |
| 53 | 47491.77 | 52496.99 | 36922.58 | 48431.77 | 53866.2433 |
| 54 | 46311.08 | 50591.04 | 36781.03 | 47150.65 | 55622.8333 |
| 55 | 46226.79 | 47845.61 | 38238.9 | 46092.92 | 53672.0833 |
| 56 | 45739.88 | 45051.88 | 37766 | 45639.09 | 51888.51 |
| 57 | 43540.71 | 44305.21 | 38154.96 | 43577.31 | 50447.7867 |
| 58 | 42095.62 | 43650.07 | 38930.82 | 43379.2 | 47793.5767 |
| 59 | 42336.89 | 44479.48 | 38178.14 | 43314.6 | 44960.6467 |
| 60 | 42623.17 | 44821.81 | 37734.59 | 43275 | 46736.9867 |
| 61 | 44346.08 | 49216.35 | 42424.42 | 48322.12 | 51801.0167 |
| 62 | 50648.16 | 53756.12 | 45840.62 | 55419.21 | 57223.8833 |
| 63 | 51602.5 | 55756.74 | 49311.48 | 56859.22 | 58591.3 |
| 64 | 51770.29 | 57655.72 | 49070.17 | 57817.78 | 59861.6667 |
| 65 | 53095.87 | 55282.69 | 50279.14 | 56318.21 | 60254.8767 |
| 66 | 50200.47 | 54768.74 | 48985.9 | 55819.22 | 60093.5733 |
| 67 | 50299.12 | 52688.45 | 48536.38 | 54564.43 | 57370.28 |
| 68 | 51105.62 | 54070.19 | 48503.54 | 53307.46 | 55943.0167 |
| 69 | 49278.14 | 51305.14 | 47085.39 | 52222.93 | 53994.0667 |
| 70 | 46884.62 | 49454.97 | 44526.66 | 48915.9 | 52683.1167 |
| 71 | 43200.19 | 48016.98 | 42887.58 | 47750.9 | 50583.7733 |
| 72 | 43752.82 | 46167.53 | 42858.33 | 46118.83 | 49700.42 |
| 73 | 40104.36 | 43856.75 | 40063.89 | 45103.34 | 47664.32 |
| 74 | 41742.3 | 44864.17 | 38279.13 | 43695.39 | 46875.32 |
| 75 | 44289.11 | 45501.63 | 38352.27 | 46080.62 | 47756.39 |
| 76 | 46581.33 | 49403.24 | 38993.92 | 46862.87 | 50948.63 |
| 77 | 46581.43 | 49793.72 | 40382.8 | 46709.85 | 50716.0767 |
| 78 | 46538.98 | 50456.43 | 39893.95 | 48552.59 | 51333.28 |
| 79 | 48831.36 | 52519.32 | 42164.99 | 49584.5 | 53208.8367 |
| 80 | 51576.29 | 53392.53 | 43233.92 | 49769.38 | 53611.2967 |
| 81 | 51137.46 | 52040.6 | 41632.82 | 51115.17 | 54716.3667 |
| 82 | 52958.78 | 53786.18 | 41280.13 | 51865.39 | 55056.8667 |
| 83 | 49214.6 | 54001.11 | 40668.33 | 51592.14 | 54977.8233 |
| 84 | 50835.18 | 53883.44 | 43481.75 | 51450.15 | 54358.2933 |
| 85 | 49725.89 | 52978.52 | 42509.82 | 50501.34 | 55952.3167 |
| 86 | 49588.72 | 54494.45 | 44593.84 | 50981.67 | 57297.0333 |
| 87 | 49991.52 | 55522.04 | 44266.93 | 51346.23 | 57082.5333 |
| 88 | 47225.99 | 55699.14 | 45501.49 | 52282.55 | 55108.31 |
| 89 | 48654.53 | 54531.32 | 44748.22 | 52759.16 | 51704.26 |
| 90 | 47244.25 | 52409.16 | 45950.21 | 50592.64 | 49311.3367 |
| 91 | 45849.82 | 51269.29 | 44077.84 | 50304.61 | 47748.6033 |
| 92 | 44304.11 | 51242.65 | 42093.57 | 48874.47 | 49275.4133 |
| 93 | 47275.25 | 52005.17 | 44450.49 | 51766.4 | 51911.2733 |
| 94 | 50635.98 | 56006.05 | 47095.96 | 57211.95 | 54758.1 |
| 95 | 52359.05 | 56245.18 | 47013.07 | 58926.67 | 54655.67 |
| 96 | 51246.99 | 55010.98 | 43570.17 | 58736.22 | 52450.2167 |
| 1 | 51246.99 | 52434.03 | 40191.5 | 41116.72 | 49606.8633 |
| 2 | 51246.99 | 46582.25 | 37202.33 | 37181.31 | 45286.3467 |
| 3 | 51246.99 | 41558.41 | 35204.08 | 33767.97 | 41268.47 |
| 4 | 51246.99 | 37464.2 | 32284.57 | 31351.88 | 38273.99 |
| 5 | 51246.99 | 33122.45 | 28433.35 | 28219.29 | 37587.2233 |
| 6 | 34068.3633 | 30257.78 | 24799.11 | 25796.94 | 33435.98 |
| 7 | 30119.31 | 28003.34 | 21212.74 | 23274.91 | 28801.48 |
| 8 | 28010.2567 | 24669.44 | 18527.38 | 20564.34 | 24920.7367 |
| 9 | 27503.9333 | 21133.33 | 15815.77 | 18609.44 | 25154.5567 |
| 10 | 24875.2833 | 18786.61 | 14517.97 | 16368.28 | 23172.1233 |
| 11 | 22254.46 | 16312.75 | 13306.01 | 14193.87 | 20684.15 |
| 12 | 20036.8867 | 14835.1 | 11453.71 | 12904.31 | 18492.21 |
| 13 | 18314.2967 | 13465.43 | 10055.57 | 11372.61 | 16774.0567 |
| 14 | 16326.7267 | 11733.24 | 9289.72 | 10969.77 | 15574.2367 |
| 15 | 14879.1 | 10904.43 | 8849.7 | 10354.59 | 14630.5133 |
| 16 | 13792.3433 | 10461.67 | 8628.13 | 9434.78 | 13300.86 |
| 17 | 13040.6367 | 10585.54 | 8148.51 | 8264.92 | 11974.3033 |
| 18 | 12526.1767 | 10219.77 | 8015.61 | 8055.37 | 11495.8933 |
| 19 | 11823.92 | 9844.92 | 7400.12 | 8013.94 | 10799.1467 |
| 20 | 9430.4733 | 9642.63 | 7518.16 | 8028.53 | 7978.7633 |
| 21 | 8976.57 | 9275.17 | 7515 | 8215.8 | 8619.6033 |
| 22 | 9225.18 | 8803.54 | 8076.19 | 8631.66 | 9265.54 |
| 23 | 9754.01 | 9727.69 | 8981.79 | 8883.5 | 10262.9 |
| 24 | 11538.7367 | 10739.41 | 10034.21 | 9907.36 | 11395.7433 |
| 25 | 13065.7967 | 11542.27 | 10739.33 | 11621.47 | 13275.0633 |
| 26 | 15128.4833 | 12815.85 | 11796.06 | 12994.09 | 15681.9167 |
| 27 | 16085.76 | 13640.44 | 13970.71 | 13692.88 | 16343.7467 |
| 28 | 16619.08 | 14801.97 | 15136.93 | 13863.81 | 18136.0433 |
| 29 | 18170.1767 | 14876.21 | 16271.65 | 14923.86 | 18775.74 |
| 30 | 22234.8 | 19992.02 | 19420.16 | 16467.38 | 21630.1867 |
| 31 | 25177.9633 | 21135.57 | 20276.75 | 17464.05 | 23609.4867 |
| 32 | 28196.04 | 25483.38 | 23583.01 | 19996.7 | 28539.59 |
| 33 | 33505.5633 | 30167.03 | 29927.57 | 23005.37 | 32098.1667 |
| 34 | 37256.65 | 35162.31 | 33794.87 | 24187.02 | 38901.76 |
| 35 | 42488.9533 | 37703.32 | 37404.38 | 27087.36 | 43266.3033 |
| 36 | 44753.57 | 41963.84 | 40941.54 | 28918.27 | 46730.4767 |
| 37 | 46475.4833 | 42873.6 | 43337.51 | 31322.68 | 46204.0333 |
| 38 | 46632.7267 | 45703.62 | 47013.26 | 33384.46 | 49358.1767 |
| 39 | 49172.7967 | 45955.59 | 47693.35 | 35937.98 | 51673.5667 |
| 40 | 47910.31 | 47823.55 | 49070.66 | 35040.14 | 52383.9633 |
| 41 | 45729.9833 | 44915.04 | 50504.23 | 36570.33 | 51683.6367 |
| 42 | 47903.9567 | 43973.65 | 49377.28 | 37729.74 | 49510.3667 |
| 43 | 49347.7633 | 43418.73 | 46848.93 | 39059.56 | 47644.3933 |
| 44 | 47477.7567 | 43472.66 | 47534.91 | 38574.48 | 46495.4967 |
| 45 | 47338.4767 | 43615.91 | 48153.3 | 37601.82 | 47175.25 |
| 46 | 48584.5933 | 44758.36 | 48658.64 | 39290.08 | 47516.7267 |
| 47 | 48418.4667 | 44759.32 | 49700.28 | 35933.11 | 48368.0933 |
| 48 | 49063.34 | 42631.18 | 49123.43 | 36418.67 | 48056.7633 |
| 49 | 49551.17 | 42862.19 | 52222.53 | 37091.95 | 49998.3133 |
| 50 | 50673.1333 | 45073.28 | 52929.41 | 36654.57 | 53629.72 |
| 51 | 53960.73 | 46226.34 | 53331.62 | 37432.97 | 54607.59 |
| 52 | 54609.3233 | 46641.81 | 52656.41 | 38206.46 | 55513.1433 |
| 53 | 52536.8467 | 47491.77 | 52496.99 | 36922.58 | 54053.76 |
| 54 | 49979.8633 | 46311.08 | 50591.04 | 36781.03 | 51750.9367 |
| 55 | 48933.4733 | 46226.79 | 47845.61 | 38238.9 | 48021.82 |
| 56 | 47237.1533 | 45739.88 | 45051.88 | 37766 | 47138.4867 |
| 57 | 45931.6 | 43540.71 | 44305.21 | 38154.96 | 48255.2067 |
| 58 | 43213.0367 | 42095.62 | 43650.07 | 38930.82 | 46020.5 |
| 59 | 43408.4633 | 42336.89 | 44479.48 | 38178.14 | 45648.43 |
| 60 | 43017.0267 | 42623.17 | 44821.81 | 37734.59 | 45801.0267 |
| 61 | 46765.14 | 44346.08 | 49216.35 | 42424.42 | 50906.4367 |
| 62 | 54831.5933 | 50648.16 | 53756.12 | 45840.62 | 58223.0567 |
| 63 | 57270.7533 | 51602.5 | 55756.74 | 49311.48 | 60299.2367 |
| 64 | 58745.0633 | 51770.29 | 57655.72 | 49070.17 | 62054.9433 |
| 65 | 56967.0633 | 53095.87 | 55282.69 | 50279.14 | 60031.2267 |
| 66 | 56342.3433 | 50200.47 | 54768.74 | 48985.9 | 58771.0033 |
| 67 | 55131.6967 | 50299.12 | 52688.45 | 48536.38 | 56764.62 |
| 68 | 54595.4533 | 51105.62 | 54070.19 | 48503.54 | 57123.59 |
| 69 | 52334.96 | 49278.14 | 51305.14 | 47085.39 | 56380.6967 |
| 70 | 48586.3933 | 46884.62 | 49454.97 | 44526.66 | 54355.75 |
| 71 | 48018.9467 | 43200.19 | 48016.98 | 42887.58 | 50191.76 |
| 72 | 48446.5467 | 43752.82 | 46167.53 | 42858.33 | 49128.7467 |
| 73 | 44757.9633 | 40104.36 | 43856.75 | 40063.89 | 46876.9067 |
| 74 | 45613.2733 | 41742.3 | 44864.17 | 38279.13 | 46765.8567 |
| 75 | 47302.55 | 44289.11 | 45501.63 | 38352.27 | 46620.9433 |
| 76 | 52229.6467 | 46581.33 | 49403.24 | 38993.92 | 50531.4233 |
| 77 | 51844.8567 | 46581.43 | 49793.72 | 40382.8 | 50878.85 |
| 78 | 51533.5667 | 46538.98 | 50456.43 | 39893.95 | 54521.27 |
| 79 | 52569.43 | 48831.36 | 52519.32 | 42164.99 | 54900.6067 |
| 80 | 53643.0567 | 51576.29 | 53392.53 | 43233.92 | 55974.9767 |
| 81 | 53608.3167 | 51137.46 | 52040.6 | 41632.82 | 58697.2167 |
| 82 | 52739.0067 | 52958.78 | 53786.18 | 41280.13 | 56587.8367 |
| 83 | 51928.0967 | 49214.6 | 54001.11 | 40668.33 | 55436.51 |
| 84 | 51156.2467 | 50835.18 | 53883.44 | 43481.75 | 56231.8033 |
| 85 | 50937.19 | 49725.89 | 52978.52 | 42509.82 | 57303.2033 |
| 86 | 51008.0133 | 49588.72 | 54494.45 | 44593.84 | 58768.5533 |
| 87 | 53734.8133 | 49991.52 | 55522.04 | 44266.93 | 57834.78 |
| 88 | 53948.3233 | 47225.99 | 55699.14 | 45501.49 | 58326.0867 |
| 89 | 50046.0567 | 48654.53 | 54531.32 | 44748.22 | 53732.05 |
| 90 | 49933.0733 | 47244.25 | 52409.16 | 45950.21 | 52111.5933 |
| 91 | 48277.12 | 45849.82 | 51269.29 | 44077.84 | 53022.4733 |
| 92 | 45897.29 | 44304.11 | 51242.65 | 42093.57 | 49800.4767 |
| 93 | 48271.2967 | 47275.25 | 52005.17 | 44450.49 | 53055.2167 |
| 94 | 53016.4133 | 50635.98 | 56006.05 | 47095.96 | 56546.8133 |
| 95 | 54919.5433 | 52359.05 | 56245.18 | 47013.07 | 56517.7533 |
| 96 | 53647.9467 | 51246.99 | 55010.98 | 43570.17 | 55220.7433 |
| 1 | 47747.6533 | 51246.99 | 52434.03 | 40191.5 | 51209.39 |
| 2 | 43371.9633 | 51246.99 | 46582.25 | 37202.33 | 48398.69 |
| 3 | 40661.7767 | 51246.99 | 41558.41 | 35204.08 | 44681.98 |
| 4 | 38484.5667 | 51246.99 | 37464.2 | 32284.57 | 41953.67 |
| 5 | 36966.96 | 51246.99 | 33122.45 | 28433.35 | 39696.53 |
| 6 | 32620.0233 | 34068.3633 | 30257.78 | 24799.11 | 35945.79 |
| 7 | 28691.35 | 30119.31 | 28003.34 | 21212.74 | 31646.32 |
| 8 | 26258.17 | 28010.2567 | 24669.44 | 18527.38 | 28496.99 |

TABLE 2
Prediction Results of Loads

| | | | | | | | | | | |
|---|---|---|---|---|---|---|---|---|---|---|
| Time point 1-10 | 25959 | 23089.33 | 20175.63 | 18065.67 | 16661.62 | 15215.42 | 13879.57 | 13073.96 | 12343.98 | 11676.35 |
| Time point 11-20 | 10966.34 | 8722.165 | 8455.629 | 8695.478 | 10013.33 | 11248.4 | 12042.52 | 13593.31 | 14230.03 | 15201.41 |
| Time point 21-30 | 15805.8 | 18820.08 | 21874.31 | 25049.86 | 29286.44 | 34563.96 | 36812.54 | 40191.5 | 42386.49 | 44529.26 |
| Time point 31-40 | 46348.05 | 48711.78 | 47964.93 | 47165.48 | 48392.99 | 48882.88 | 48526.08 | 48050.94 | 48142.09 | 47813.67 |
| Time point 41-50 | 48629.06 | 49599.98 | 51004.22 | 50750.2 | 50563.81 | 50686.13 | 50641.65 | 49705.01 | 49538.61 | 47786.01 |
| Time point 51-60 | 46707.99 | 47197.81 | 51507.18 | 56628.56 | 57864.54 | 57902.59 | 57745.96 | 57028.3 | 55836.18 | 54696.5 |
| Time point 61-70 | 53661.37 | 51552.84 | 49630.5 | 48250.77 | 46315.07 | 45827.73 | 47038.56 | 49424.06 | 50760.74 | 51121.08 |
| Time point 71-80 | 51315.05 | 52415.6 | 53246.39 | 52191.42 | 51440.23 | 51361.62 | 50964.64 | 52918.81 | 53197.82 | 51911.91 |
| Time point 81-90 | 50217.39 | 48459.88 | 47188.8 | 46599.47 | 50271.91 | 54296.36 | 54071.33 | 51966.17 | 48772.19 | 44681.89 |
| Time point 91-96 | 40705.32 | 37073.52 | 36694.19 | 31991.7 | 28065.65 | 25219.18 | | | | |

It should be emphasized that the embodiments of the present invention are illustrative, rather than restrictive. Therefore, the present invention includes but not limited to the embodiments in detailed description. All other implementation manners obtained by those skilled in the art according to the technical solutions of the present invention belong to the protection scope of the present invention.

We claim:

1. A prediction method for charging loads of electric vehicles with consideration of data correlation, comprising the following steps:
Step 1: collecting historical data of charging loads of electric vehicles;
Step 2: carrying out data correlation analysis on the historical data of the charging loads of the electric vehicles, which is collected in Step 1, and real-time data, and calculating correlation coefficients between the historical data of the charging loads of the electric vehicles and the real-time data;
Step 3: according to the correlation coefficients obtained through calculation in Step 2, selecting historical data of the charging loads of the electric vehicles, which has high correlation, as data of the charging loads of the electric vehicles, which is used for prediction;
Step 4: predicting the historical data of the charging loads of the electric vehicles, which has high correlation and is selected in Step 3, serving as the data of the charging loads of the electric vehicles, which is used for prediction, by adopting an LSTM (Long Short Term Memory) algorithm, to obtain prediction results.

2. The prediction method for charging loads of electric vehicles with consideration of data correlation according to claim 1, wherein a specific method of the Step 1 comprises: collecting the historical data of the charging loads of the electric vehicles of that very day and ten typical days at a certain area.

3. The prediction method for charging loads of electric vehicles with consideration of data correlation according to claim 1, wherein a specific method of the Step 2 comprises: calculating the correlation of historical data of the charging loads of the electric vehicles of each day and real data of that very day by utilizing Excel software, to obtain the correlation coefficients between the historical data of the charging loads of the electric vehicles and the real-time data, wherein a calculation formula is:
$${r}_{xy} = \frac{{S}_{xy}}{{S}_{x} {S}_{y}} \qquad ( 1 )$$
wherein r_{xy} represents a correlation coefficient of samples; S_{xy} represents a sample covariance; Sₓ represents a sample standard deviation of x; and S_{y} represents a sample standard deviation of y; in this case, x represents the data of the ten typical days, and y represents the data of that very day.

4. The prediction method for charging loads of electric vehicles with consideration of data correlation according to claim 1, wherein a specific method of the Step 3 comprises:
according to a sequence of the correlation coefficients from small to big, selecting top five groups of data with biggest correlation coefficients, i.e., five groups of data with the highest correlation, as the data of the charging loads of the electric vehicles, which is used for prediction.

5. The prediction method for charging loads of electric vehicles with consideration of data correlation according to claim 1, wherein the Step 4 specifically comprises the following steps:
(1) inputting the data Xₜ of the charging loads of the electric vehicles, which is used for prediction and is obtained in Step 3, and carrying out processing of a forgetting stage of a forgetting gate on load data Xₜ of each time point firstly, wherein a calculation formula is shown as follows:
fₜ=σ(W_{f}·[hₜ₋₁,xₜ]+b_{f})
(2) then, carrying out processing of a cell state updating stage of an input gate on fₜ, wherein a calculation formula is shown as follows:
Cₜ=fₜ*Cₜ₋₁+iₜ*\tilde{C}t
(3) finally, carrying out processing of an output stage of an output gate on Cₜ, wherein calculation formulas are shown as follows:
0ₜ=σ(Wₒ·[hₜ₋₁,xₜ]+bₒ)
hₜ=0ₜ*tan h(Cₜ)
(4) taking load data obtained after the load data of one time point is processed by the three gate stages as legacy information hₜ₋₁ of a previous cell, and enabling the legacy information hₜ₋₁ and load data of a new time point to participate in recursive processing of the three gate stages again, to obtain load prediction values hₜ of 96 time points in one day finally.
